(19) United States
(12) Patent Application Publication
(10) Pub. No.: US 2024/0393434 A1
(43) Pub. Date: Nov. 28, 2024

(54) PROCESSING OF LIDAR SENSOR DATA

(71) Applicant: CONTINENTAL AUTONOMOUS MOBILITY GERMANY GMBH, Ingolstadt (DE)

(72) Inventors: Olivier DIRAT, Toulouse (FR); Boris LUGEZ, Toulouse (FR)

(73) Assignee: Continental Autonomous Mobility Germany GmbH, Ingolstadt (DE)

(21) Appl. No.: 18/701,651

(22) PCT Filed: Nov. 2, 2022
(86) PCT No.: PCT/EP2022/080562

§ 371 Date: Apr. 16, 2024

(30) Foreign Application Priority Data
Nov. 8, 2021 (FR) FR2111822

(51) Int. Cl. G01S 7/48; G01S 17/42; G01S 17/89; G01S 17/931

(52) U.S. Cl. CPC G01S 7/4802; G01S 17/42; G01S 17/89; G01S 17/931

(57) ABSTRACT

The disclosure relates to a data processing device for a LiDAR sensor mounted on a vehicle. The data processing device is used to determine whether groups of pixels of a matrix of pixels obtained by the LiDAR sensor correspond to clouds of particles, notably based on a distribution of normal vectors associated with these pixels.

### CROSS REFERENCE TO RELATED APPLICATIONS

This application is the U.S. National Stage Application of PCT International Application No. PCT/EP2022/080562, filed Nov. 2, 2022, which claims priority to French Application No. 2111822, filed Nov. 8, 2021, the contents of such applications being incorporated by reference herein.

### FIELD OF THE INVENTION

The present invention relates to a device and a method for processing data for a LIDAR sensor.

### BACKGROUND OF THE INVENTION

A LIDAR (Light Detection And Ranging) sensor is a sensor emitting light waves and determining, based on the reflection of these light waves, a matrix mapping an environment of the LiDAR sensor.

The matrix of the environment of the LiDAR sensor can comprise suspended particles and notably, when the LiDAR sensor is on board a vehicle, suspended particles originating from exhaust gases.

Within the context of a LIDAR sensor positioned on a vehicle traveling on the road network, there are numerous suspended particles, notably due to the exhaust gases of the various vehicles and they can prevent correct interpretation of the matrix of the environment of the LiDAR sensor.

A solution proposed by document U.S. Pat. No. 8,818,609 involves determining whether a zone of points obtained by the LiDAR sensor corresponds to exhaust gases or if it is a zone corresponding to a solid object based on a density profile and an elevation profile of these points. More specifically, the density and elevation profiles are compared with previously determined profiles and a classifier is used to determine whether it is exhaust gas or a solid object based on the comparison.

However, this solution is limited insofar as a solid object also can be included in the exhaust gases and, in this case, discriminating between the exhaust gases and the solid object can prove to be difficult.

In this sense, the precision involved in detecting the suspended particles and in discriminating objects in these particles therefore can be improved.

### SUMMARY OF THE INVENTION

A first aim of the present disclosure therefore involves proposing an alternative device and method adapted to detect whether a group of points (pixels) obtained by a LIDAR sensor adapted to be mounted on a vehicle fully or partly corresponds to a cloud of particles.

Another aim of the present disclosure involves allowing the device and the method to detect whether, within this group of pixels previously identified as fully or partly belonging to a cloud of particles, pixels correspond to solid elements other than particles.

In this respect, the present disclosure describes a data processing device for a LIDAR sensor adapted to be mounted on a vehicle, the device comprising a computer configured for:
obtaining a matrix of pixels acquired by the LiDAR sensor, with each pixel of the matrix being associated with a light intensity and with a position in a three-dimensional space;
identifying at least one group of neighboring pixels of the matrix of pixels; and,
for at least one identified group of neighboring pixels:
determining a plurality of normal vectors associated with the pixels of the group of neighboring pixels;
identifying whether the group of neighboring pixels fully or partly belongs to a cloud of particles based on a substantially homogeneous distribution of the plurality of normal vectors associated with the pixels of the group of neighboring pixels.

Optionally, the computer is also configured for determining, for at least one specific pixel of the group of neighboring pixels identified as fully or partly belonging to a cloud of particles, whether the specific pixel belongs to a solid element other than the cloud of particles.

Optionally, the computer is configured for determining that the specific pixel belongs to a solid element when an intensity associated with the pixel is greater than an intensity threshold associated with a determined solid element.

Optionally, the computer is further configured for determining an average distance of the group of neighboring pixels relative to the LiDAR sensor. A group of neighboring pixels can be a candidate to be identified as fully or partly belonging to the cloud of particles when an average distance of the pixels of the group of neighboring pixels relative to the LiDAR sensor is less than a predetermined distance threshold.

Optionally, the computer is further configured for determining an average intensity of the group of neighboring pixels and an average distance of the group of neighboring pixels relative to the LiDAR sensor. A group of neighboring pixels can be a candidate to be identified as fully or partly belonging to the cloud of particles when an average intensity of the pixels of the group of neighboring pixels is less than a determined intensity threshold, with the intensity threshold being determined based on the average distance of the group of pixels.

Optionally, the computer is further configured for determining an azimuth angle for each of the pixels of the group of neighboring pixels. A group of neighboring pixels can be a candidate to be identified as fully or partly belonging to the cloud of particles when a distribution of the azimuth angle of the pixels of the group of neighboring pixels substantially corresponds to a predetermined model.

Optionally, the computer is configured for identifying a group of neighboring pixels as corresponding to a plurality of pixels for which each pixel is at a distance below a predetermined neighboring threshold from another pixel of the group of pixels.

According to another aspect, the present disclosure describes a vehicle fitted with a data processing device according to any of the options described above. The computer of the data processing device is then configured for identifying a cloud of particles comprising exhaust gas particles.

According to another aspect, the present disclosure describes a method for processing data from a LiDAR sensor mounted on a vehicle, characterized in that it comprises:
obtaining a matrix of pixels acquired by the LiDAR sensor, with each pixel of the matrix being associated with a light intensity and with a position in a three-dimensional space;
identifying at least one group of neighboring pixels of the matrix of pixels; and, for at least one identified group of neighboring pixels:
determining a plurality of normal vectors associated with the pixels of the group of neighboring pixels;
identifying whether the group of neighboring pixels fully or partly belongs to a cloud of particles based on a substantially homogeneous distribution of the plurality of normal vectors associated with the pixels of the group of neighboring pixels.

Optionally, the method further comprises determining, for at least one specific pixel of the group of neighboring pixels, whether the specific pixel belongs to a solid element other than the cloud of particles.

The present disclosure also describes a computer program product comprising instructions for implementing any one of the methods described in the present document when it is implemented by a computer. It also describes a non-transient computer-readable storage medium storing code instructions for implementing any one of the methods described in the present document.

### BRIEF DESCRIPTION OF THE DRAWINGS

Further features, details and advantages of aspects of the invention will become apparent from reading the following detailed description and from analyzing the appended drawings, in which:

FIG. 1A shows an example of a data processing device;

FIG. 1B shows another example of a data processing device;

FIG. 2 shows an example of a LIDAR sensor mounted on a vehicle;

FIG. 3 shows an example of different blocks that a computer of the data processing device is configured to control;

FIG. 4 shows an example of a group of neighboring pixels and an example of several sub-sets of pixels;

FIG. 5A shows an example of homogeneous distribution of the directions of the normal vectors of the pixels of a group of pixels;

FIG. 5B shows an example of heterogeneous distribution of the directions of the normal vectors of the pixels of a group of pixels;

FIG. 6A shows an example of distribution of the azimuth angles of the pixels of a group of pixels;

FIG. 6B shows another example of distribution of the azimuth angles of the pixels of a group of pixels.

### DETAILED DESCRIPTION OF THE PREFERRED EMBODIMENTS

The present disclosure describes a data processing device for a LIDAR sensor comprising a computer configured for implementing various actions. These various actions are notably used to identify whether a group of pixels obtained from the LiDAR sensor and describing the environment of the LiDAR fully or partly belongs to a cloud of particles. Optionally, it is also possible to determine whether a specific pixel of the group of pixels identified as fully or partly belonging to a cloud of particles belongs to a solid element other than the cloud of particles.

These possibilities offered by the processing device are particularly advantageous, notably within the context of autonomous vehicle traffic. Indeed, a LIDAR sensor mounted on a vehicle allows the environment around the vehicle to be mapped. This mapping notably can include information relating to clouds of particles or to solid elements. In particular, clouds of particles on the LiDAR matrix can correspond, for example, to exhaust gases of vehicles (and notably of the vehicle on which the LiDAR is mounted). With respect to solid elements, they can represent obstacles, for example, other vehicles surrounding the vehicle on which the LiDAR is mounted.

However, it is understood that the acquired information, from the perspective of the LiDAR, whether it is a cloud of particles or a solid element other than the cloud of particles, simply represents a set of pixels. However, for processing functions using the information received from the LiDAR, and notably the driving functions of the autonomous vehicles, a cloud of particles must not be interpreted as being an obstacle since this does not entail any danger for passengers and for the vehicle, unlike a solid element.

The processing device described in the present disclosure is thus suitable for implementing a solution that identifies groups of pixels that can fully or partly correspond to clouds of particles and optionally that can distinguish, from among these groups, pixels corresponding to solid elements other than particles.

In this case, the solution that is described is a pre-processing solution in the sense that more in-depth processing can be carried out following the solution to ensure that solid elements detected by the processing device do not correspond to “false positives”. The solution that is described can thus deliberately discriminate between groups of pixels for which there is a significant presumption that they correspond to solid elements so that they are directly processed using such more in-depth processing. This allows the capabilities for detecting a solid element to be maintained, which solid element could harm the physical integrity of the passengers and damage the vehicle.

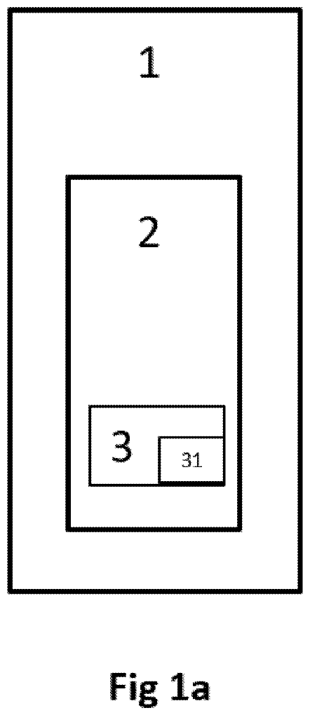

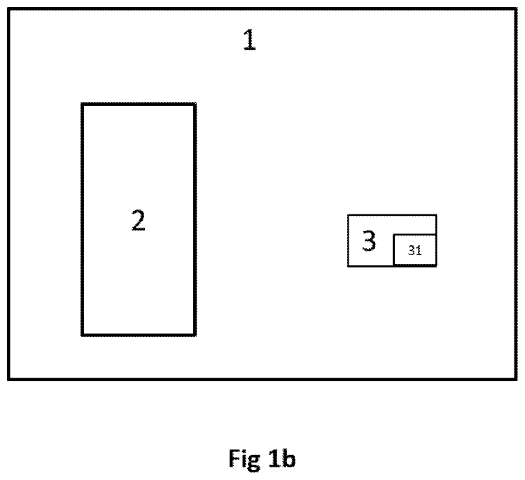

Reference will now be made to FIGS. 1A and 1B, which show examples of a data processing device 1 for a LIDAR sensor 2.

A data processing device 1 can comprise a computer 3 adapted to execute code instructions allowing the data processing device to control several data processing blocks linked to the LiDAR sensor 2.

The code instructions can be stored, for example, in a memory 31 accessible to the computer 3. The computer 3 can be a processor, a controller or a microcontroller, for example. It is therefore connected to the memory 31 so as to be able to use the information contained therein.

The memory 31 can include, for example, a ROM (read-only memory), a RAM (random access memory), an EEPROM (electrically erasable programmable read-only memory) or any other type of suitable storage means for reading code instructions. The memory can include, for example, optical, electronic or even magnetic storage means.

In FIG. 1A, an example of a data processing device 1 comprises the LIDAR sensor 2, the computer 3 and the memory 31. In particular, in the example shown, the LiDAR sensor 2 comprises the computer 3 and the memory 31. A non-limiting example of a data processing device can therefore correspond to a LiDAR sensor 2 comprising the computer 3 and the memory 31. In this embodiment, the LIDAR sensor 2 can be physically connected to the memory 31 of the computer 3 so that the data obtained by the LiDAR sensor following the emission of light beams are transmitted by wired connections to the memory 31 in order to be stored. The data processing controlled by the computer 3 based on the data contained in the memory 31 and described hereafter by the present disclosure can therefore occur locally on the LiDAR sensor.

Another example of a data processing device 1 is shown in FIG. 1B. In this example, the data processing device comprises a LIDAR sensor 2, which can be connected to a computer 3 with a memory 31 via telecommunications channels. The LiDAR sensor 2 and the computer 3 with the memory 31 therefore can be remote and the data obtained by the LiDAR sensor 2 are sent by means of the telecommunication channels to the computer 3 so as to be stored in the memory 31. The computer 3 and the memory 31 can form part of a remote server, for example. The telecommunications channels can include, for example, 3G, 4G, 5G, optical, electromagnetic, etc. channels.

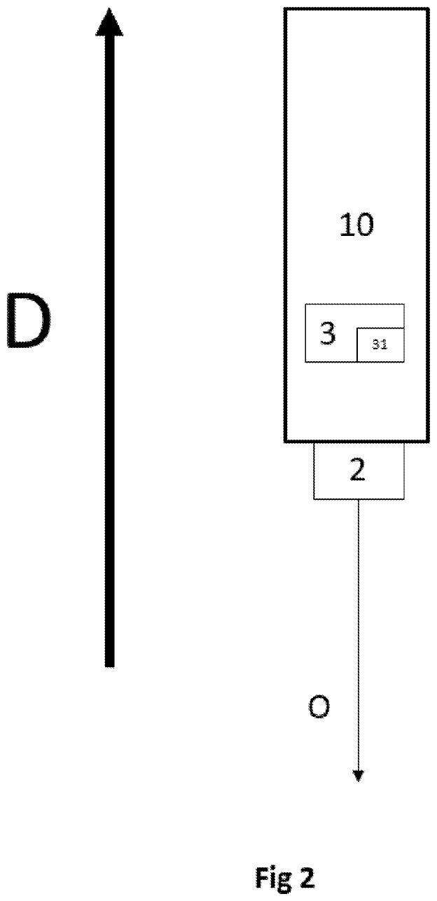

In this case, when the LiDAR sensor 2 is mounted on a vehicle 10, and advantageously at the rear of the vehicle 10, the data can be processed by a computer 3 directly located on the vehicle, as shown in FIG. 2. In this figure, the arrow D represents the direction of travel of the vehicle 10 and the arrow O represents the optical axis of the LiDAR sensor. In this configuration, the computer also can be understood to be the LiDAR sensor, as in the example shown in FIG. 1a, or can simply correspond to another computer present on the vehicle 10, as shown in FIG. 2. The computer 3 can be, for example, the electronic control unit of the vehicle 10. As an alternative embodiment, the LiDAR sensor 2 is mounted on the vehicle 10 and the computer 3 is located on a server remote from the vehicle 10. The data is therefore processed on the remote server.

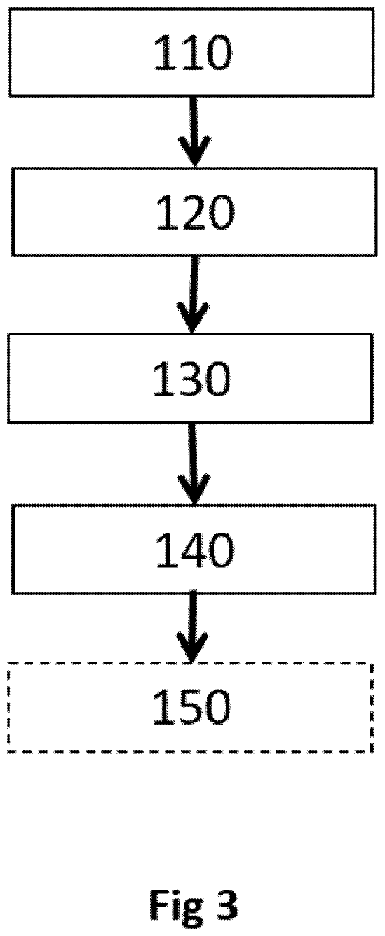

With reference to FIG. 3, a method is described hereafter that the computer 3 of the data processing device 1 is configured to implement.

As illustrated by the block 110, the computer 3 is configured to obtain a matrix of pixels p acquired by the LiDAR sensor 2. The matrix is determined by the LiDAR 2 via the emission of a light beam, which is reflected and received by said LiDAR 2, thus allowing the matrix of pixels p to be formed. Each pixel p of the matrix is assigned an intensity I, corresponding to the light intensity received by the pixel, and a position (x, y, z) in a three-dimensional space, where x and y are the Cartesian coordinates of the pixel p and z is a depth coordinate. The x, y and z coordinates are computed based on a position of the pixel p on a receiver matrix of the LiDAR 2 and based on a distance of the pixel p relative to the LiDAR sensor. The distance of the pixel p relative to the LiDAR sensor is determined as a function of the time between the emission of the beam and its reception by the LiDAR 2. The matrix of pixels is then stored in the memory 31 of the computer 3 by using suitable communication channels as a function of the data processing device that is used.

As illustrated by the block 120, the computer 3 is configured for identifying at least one group of neighboring pixels of the matrix M of pixels. Two pixels of the matrix of pixels can correspond to neighboring pixels if a distance between these pixels is less than a predetermined neighboring threshold. In one example, the computer can be configured for identifying a group of neighboring pixels as corresponding to a plurality of pixels, each pixel of which is at a Euclidean distance that is less than the predetermined neighboring threshold of another pixel of the group of pixels. A distance can be computed based on the coordinates of the pixels in the three-dimensional space. In this block, this involves determining one or more groups of candidate pixels that can fully or partly belong to a cloud of particles.

Each time a distance is referred to in the present document, it can involve a Euclidean distance determined based on the coordinates of the pixels in the three-dimensional space.

The computer of the data processing device is also configured for implementing the actions of the blocks 130 to 150 and their various associated examples described hereafter for at least one group of neighboring pixels identified at the end of the block 120 and advantageously for all the groups of pixels. These blocks will be used to determine whether an identified group of neighboring pixels fully or partly belongs to a cloud of particles and, optionally, if pixels of this group of neighboring pixels belong to a solid element other than the cloud of particles.

The processing of the data described in these blocks therefore applies to each group of pixels identified at the end of the block 120. However, for the sake of clarity, these blocks will be described for a group of neighboring pixels, yet bearing in mind that they can be individually applied to each of the groups of identified pixels.

Thus, and as illustrated by the block 130, the computer 3 is configured for determining a plurality of normal vectors associated with the pixels of the group of neighboring pixels. In this step, this can involve determining a normal vector associated with each of the pixels of the group of neighboring pixels.

A vector normal to a pixel is understood to be a vector normal to a local surface of the group of neighboring pixels passing through the considered pixel. This local surface can be approximated by an average plane passing through pixels of the group of neighboring pixels.

A normal vector associated with a specific pixel of a group of neighboring pixels can be determined, for example, based on a sub-set of pixels comprising the specific pixel. In this respect, the computer also can be configured for determining, for each specific pixel of the group of neighboring pixels, a sub-set of pixels associated with the specific pixel.

The computer can be configured, for example, for determining a sub-set of pixels comprising the specific pixel based on a distance between the pixels of the group of neighboring pixels and the specific pixel.

In one embodiment, a sub-set of pixels can include a plurality of pixels located at a distance that is less than a predetermined sub-set distance threshold of the specific pixel. In this respect, a specific pixel substantially can be a central pixel of the sub-set of pixels.

In another embodiment, a sub-set of pixels can include a predetermined number n of pixels, with the pixels of the sub-set being able, for example, to correspond to the n−1 pixels closest to the specific pixel.

Examples of sub-sets of pixels for determining a normal vector for a specific pixel of a group of neighboring pixels are shown in FIG. 4. In particular, FIG. 4 shows a group G of neighboring pixels comprising a plurality of pixels p.

The examples of sub-sets of pixels shown in FIG. 4 are the sub-sets S1, S2, S3, S4 and S5, in which sub-sets the specific pixels respectively associated with each of the sub-sets are ps1, ps2, ps3, ps4 and ps5.

The radius of the circles illustrating the sub-sets S1, S2, and S3 represents an example of a predetermined sub-set distance threshold. In this case, FIG. 4 is represented in two dimensions, but it will be understood that the principle can be applied in three dimensions, since the pixels are associated with three-dimensional coordinates and the circles shown in reality can be spheres. The sub-sets S4 and S5 for their part represent sub-sets comprising a predetermined number n of pixels (seven pixels in the example illustrated in two dimensions) corresponding to the n−1 closest pixels of the specific pixel.

In this case, based on a sub-set of pixels associated with a specific pixel, the computer can be configured for determining an average plane associated with the specific pixel. The average plane of a specific pixel can correspond to a plane minimizing a distance between all the pixels of the sub-set of pixels associated with the specific pixel and can be determined based on the three-dimensional coordinates of each of the pixels of the sub-set of pixels.

In this embodiment, the computer can be configured for determining that the normal vector associated with a specific pixel of the group of neighboring pixels corresponds to the vector normal to the average plane associated with said specific pixel. The plurality of normal vectors associated with the pixels of the group of neighboring pixels obtained at the end of the block 160 can be determined, for example, using the respective average plane of each of the pixels of the group of pixels.

In examples, the computer 3 can be configured for computing an average distance of a group of neighboring pixels relative to the LiDAR sensor. In particular, the computer can be configured for determining an average distance of a group of neighboring pixels relative to the LiDAR sensor based on the three-dimensional coordinates of each of the pixels of the relevant group of neighboring pixels. The average distance of a group of neighboring pixels relative to the LiDAR sensor can be determined, for example, based on an average of the individual Euclidean distance of each pixel of the group relative to the LiDAR sensor. The average distance can be subsequently used in order to refine an identification diagnosis of the group of neighboring pixels as belonging or not belonging to a cloud of particles. In this case, a group of neighboring pixels will not be able to form all or part of a cloud of particles based on a certain distance, as long as at this distance the refinement of the particles would not allow them to sufficiently reflect the light beam emitted by the LiDAR sensor in order for this reflection to be detected by said sensor.

In examples, the computer 3 can be configured for determining an average intensity of the group of pixels. The average intensity can correspond to the sum of the intensities of each of the pixels of the group of neighboring pixels divided by the number of pixels of the group of neighboring pixels. The average intensity can be subsequently used in order to refine a diagnosis for identifying the group of pixels as belonging or not belonging to a cloud of particles. Indeed, since the particles are very small, they slightly reflect the light beam of the LiDAR sensor and an average intensity of the group of neighboring pixels is used to determine whether this group of neighboring pixels could fully or partly belong to a cloud of particles.

In examples, the computer 3 can be configured for determining an azimuth angle for each pixel of the group of neighboring pixels relative to the LiDAR sensor. An azimuth angle of a specific pixel is defined as being an angle, on a horizontal plane, between a direction corresponding to the optical axis of the LiDAR sensor and a direction of a straight line connecting the LiDAR and passing through the specific pixel projected onto the horizontal plane. In examples, an azimuth angle associated with a pixel can be expressed as radians and can range between −π/2 and π/2. An azimuth angle is determined for a pixel based on its position (x, y, z) in the three-dimensional space. A distribution of the azimuth angles associated with the pixels of the group of pixels can be subsequently used in order to refine a diagnosis for identifying the group of pixels as belonging or not belonging to a cloud of particles.

As illustrated by the block 140, the computer 3 is configured for identifying whether the group of neighboring pixels fully or partly belongs to a cloud of particles. This identification is carried out based on a distribution of the plurality of normal vectors associated with the pixels of the group of neighboring pixels. The distribution of the plurality of normal vectors associated with the pixels of the group of neighboring pixels advantageously comprises all the pixels of the group of neighboring pixels. The distribution of the plurality of normal vectors advantageously relates to the directions (orientations) of the normal vectors of the group of neighboring pixels.

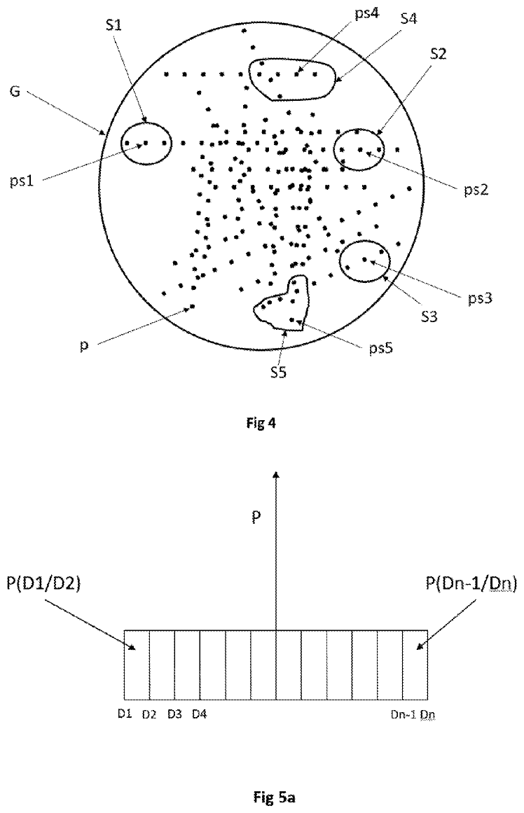

The distribution of the directions of the normal vectors of a group of neighboring pixels extends between a first direction D1 and a last direction Dn respectively corresponding to a direction of a normal vector associated with a first pixel and a direction of a normal vector associated with a second pixel of the group of neighboring pixels. This distribution comprises several ranges of directions intersecting the distribution between the first direction D1 and the last direction Dn in a plurality of ranges of directions, as shown in FIGS. 5A and 5B. In examples, each range of directions allows the same deviation of directions between its two limits.

In one embodiment, a group of neighboring pixels is identified as fully or partly belonging to a cloud of particles when a distribution of the directions of the plurality of normal vectors associated with the pixels of the group of neighboring pixels is substantially homogeneous.

A substantially homogeneous distribution of the directions of the plurality of normal vectors associated with the pixels of the group of neighboring pixels corresponds to a substantially smooth, substantially flat distribution of probabilities. In other words, a distribution in which significant deviations in probabilities are not observed for finding a pixel in a first range of directions rather than in a second range of directions. In other words, for a distribution of a given group of neighboring pixels, a substantially equivalent number of pixels of the group is included in each range of directions of the normal vectors of the distribution. In the present application, a pixel included in a range of directions of the normal vectors designates a pixel for which the direction of the normal vector lies between two directions Dn-1 and Dn forming a range of directions. Thus, a perfectly homogeneous distribution of the directions of the plurality of normal vectors means that if a pixel is randomly selected from among the pixels of the group of neighboring pixels used for the distribution, this pixel will have exactly the same probability of belonging to each of the ranges of directions represented among said distribution.

In this case, the inventors have ingeniously used the fact that a cloud of particles, when it is dispersed in an open environment, almost immediately reaches its maximum entropy state. This maximum entropy state corresponds, from a microscopic perspective, to an equiprobability for each particle to be found in all the various possible states associated with the cloud of particles. This therefore results, for each pixel of the group of neighboring pixels and from the perspective of the directions of the normal vectors, in an equiprobable distribution of the pixels of the group of neighboring pixels in each of the ranges of directions of the plurality of ranges of directions. Thus, when a distribution of the directions of the normal vectors of the group of neighboring pixels is substantially homogeneous, this group of pixels is identified as fully or partly belonging to a cloud of particles.

An example of homogeneous distribution of the directions of the vectors is shown in FIG. 5A, while an example of heterogeneous distribution of the directions of the vectors is shown in FIG. 5B. The abscissa axis represents the various ranges of directions D1/D2 to Dn-1/Dn of the normal vectors of the group of neighboring pixels, while the ordinate axis represents a probability P of the appearance of a pixel. A range of directions of the distribution is therefore associated with a probability of the appearance of a pixel in this range. In this case, a height of a rectangle P (D1/D2) shown in the figures corresponds to the probability of selecting a pixel associated with a normal vector, the direction of which lies between a direction D1 and a direction D2 from among the pixels of the group of neighboring pixels.

A probability of appearance associated with a specific direction range is equal to the number of pixels of the group of neighboring pixels used for distribution and associated with normal vectors whose directions lie between the limits of the specific range, divided by the total number of pixels of the group of neighboring pixels used for the distribution. In the case of the probability of appearance P (D1/D2), it is equal to the number of pixels of the group of neighboring pixels used for the distribution and associated with normal vectors whose directions lie between the directions D1 and D2, divided by the total number of pixels of the group of neighboring pixels used for the distribution.

In the example of FIG. 5A, the probability of selecting a pixel from among the pixels used for distribution in each of the ranges of directions is equal. This is a perfectly homogeneous distribution of the directions of the normal vectors of the group of neighboring pixels. This case is a theoretical case illustrating what a homogeneous distribution of the directions of the normal vectors looks like and illustrating what the distribution of the theoretical normal vectors of the particles of a cloud of particles looks like.

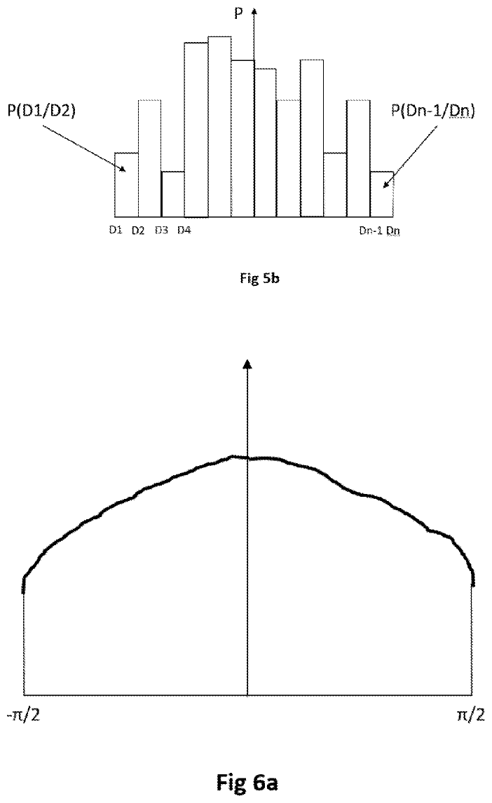

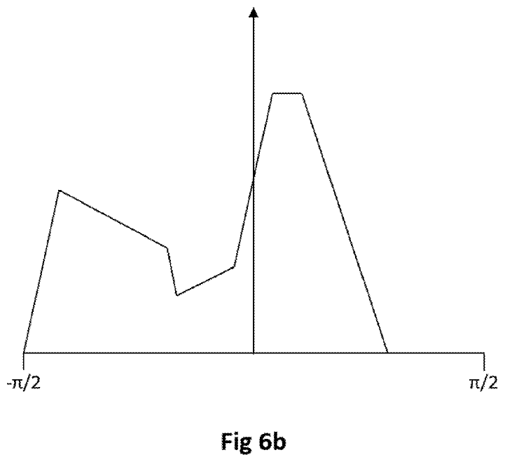

Conversely, FIG. 5B shows different probabilities of finding a pixel in various ranges of directions of the distribution in which the differences in probabilities between the ranges are significant. FIG. 6B therefore shows a heterogeneous distribution of the directions of the normal vectors of the group of neighboring pixels.

The directions of the normal vectors are illustrated by ranges between two directions in FIGS. 5A and 5B, since there is an infinite number of possible directions (possible states) of normal vectors for a group of neighboring pixels as long as the normal vectors are computed based on the three-dimensional coordinates of the pixels. In this sense, a distribution of each direction of the normal vectors of a group of pixels without defining a prior range may not be usable. Indeed, it is possible to find a different direction for each pixel (since it is possible to have an infinite number of directions) and to obtain a homogeneous distribution where each direction has a probability of one divided by the total number of pixels of the group of neighboring pixels, while a distribution of the pixels between several ranges of directions would have yielded a completely different result.

In examples, a distribution of the directions of the vectors is substantially homogeneous when a variance of the probabilities of the appearance of the pixels in the various ranges of directions of the normal vectors of the group of pixels is less than a predetermined direction variance probability threshold.

In examples, a homogeneous distribution of the plurality of normal vectors of a group of pixels can be evaluated based on a homogeneity score of directions. The homogeneity score of directions can be determined as a function of the various probabilities of the appearance of the pixels over the ranges and as a function of the number of pixels considered in the distribution. In one example, when the homogeneity score of directions is greater than a predetermined threshold of the homogeneity of directions, the distribution of the directions of the normal vectors of the group of neighboring pixels is considered to be homogeneous.

Thus, the processing device described in the present disclosure, and in particular its computer, is configured for identifying whether a group of neighboring pixels fully or partly belongs to a cloud of particles based on a distribution of the directions of the normal vectors associated with the pixels of the group of neighboring pixels.

Options are described hereafter for assisting the diagnosis for identifying a group of pixels as fully or partly belonging to the cloud of particles. These options notably can be used to disqualify a group of neighboring pixels before computing the distribution of the normal vectors, for example, in order to prioritize resources of the computer to another group of neighboring pixels.

Thus, in examples, the computer 3 also can be configured for determining that a group of neighboring pixels is a candidate to be identified as fully or partly belonging to the cloud of particles when the average distance of the pixels of the group of neighboring pixels relative to the LiDAR sensor is less than a predetermined distance threshold. The term “candidate” is understood to mean that the group of neighboring pixels is preserved in order to compute the distribution of the normal vectors in order to determine whether this group of pixels belongs to a cloud of particles.

As stated above, a group of pixels will not be able to form all or part of a cloud of particles based on a certain distance as long as at this distance the fineness of the particles would not allow them to sufficiently reflect the light beam emitted by the LiDAR sensor. In this respect, when the average distance of the pixels of the group of neighboring pixels is greater than the predetermined distance threshold, this group of neighboring pixels can include a solid element other than a cloud of particles and can be directly processed by other more in-depth processing functions so that it can be detected. This notably ensures the safety of the users and of the vehicle when the data processing device is on board a vehicle.

In examples, the computer 3 also can be configured for determining that a group of neighboring pixels is a candidate to be identified as fully or partly belonging to the cloud of particles when the average intensity of the group of pixels is less than a determined intensity threshold. The intensity threshold can be determined as a function of an average distance of the cloud of particles.

Indeed, and as previously stated, as long as the particles are very small and contain very little material, the light beam emitted by the LiDAR sensor 2 is only slightly reflected on them and the average intensity of a group of pixels that can correspond to a cloud of particles is, therefore, low and decreases as a function of the distance.

Predetermined intensity thresholds therefore can be associated with distances and the determined intensity threshold selected for the comparison can correspond, for example, to the predetermined intensity threshold whose distance is closest to the average distance of the group of particles. It is also possible to determine an intensity threshold associated with the average distance of the cloud of particles by linear interpolation based on predetermined intensity thresholds. Indeed, the intensity of the pixels decreases quadratically relative to the distance. The intensity threshold notably can depend on the LiDAR sensor. Tests on test benches thus can be carried out on the LiDAR sensor in order to previously determine different values of intensity thresholds as a function of distances.

In this case, an average intensity of the group of neighboring pixels that is greater than the determined intensity threshold means that the group of neighboring pixels can fully or partly belong to a solid element other than the cloud of particles. Indeed, a solid object reflects more of the light beams emitted by the LIDAR sensor, which results in an increase in the intensity associated with the various pixels. In this case, the group of neighboring pixels is no longer a candidate to be identified as fully or partly belonging to a cloud of particles, but can be directly processed by other more in-depth processing functions allowing a solid element to be detected in a group of pixels.

In examples, the computer 3 also can be configured for determining that a group of neighboring pixels is a candidate to be identified as fully or partly belonging to a cloud of particles based on a distribution of the azimuth angles associated with the pixels of the group of neighboring pixels. The distribution of the azimuth angle of the group of pixels advantageously comprises all the pixels of the group of neighboring pixels.

In examples, a group of neighboring pixels is a candidate to be identified as fully or partly belonging to the cloud of particles when the distribution of the azimuth angle of the group of neighboring pixels substantially corresponds to a predetermined model.

In examples, the predetermined model comprises a minimum at both ends of the distribution of the azimuth angle of the group of neighboring pixels and a maximum that is substantially in the middle of the distribution of the azimuth angle of the group of neighboring pixels. In other words, when the distribution of the azimuth angle of the group of neighboring pixels extends between a minimum angle corresponding to −π/2 and a maximum angle corresponding to π/2, a maximum probability of the appearance of a pixel should be observed at an angle substantially corresponding to 0, while two minimum probabilities of appearance must be observed, respectively at −π/2 and π/2. This example is notably shown in FIG. 6A.

In examples, the predetermined model comprises a maximum probability of the appearance of a pixel in the middle of the range of azimuth angles of the pixels of the group of distributed neighboring pixels and a gradual decrease in this probability of appearance in the middle toward each end of the range. In examples, this gradual decrease reaches a respective minimum probability of appearance at each end of the range of the azimuth angle of the pixels of the group of distributed neighboring pixels.

An example of the distribution of azimuth angles of a group of neighboring pixels for which the group of neighboring pixels would be a candidate to be identified as fully or partly belonging to a cloud of particles is shown in FIG. 6A. This distribution substantially corresponds to a predetermined model.

Conversely, an example of distribution that does not substantially correspond to a predetermined model is shown in FIG. 6B in order to illustrate a contrast between a distribution of the azimuth angle for which the group of neighboring pixels could be a candidate to be identified as fully or partly belonging to a cloud of particles and a distribution of the azimuth angle for which the group of neighboring pixels could not be a candidate.

In these illustrated examples, the distributions include pixels whose azimuth angles extend between a minimum angle corresponding to −π/2 and a maximum angle corresponding to π/2. However, these are only illustrative examples and it should be noted that the angular range of azimuth angles covered by a group of neighboring distributed pixels can be lower than that shown. In this case, the predetermined model is adapted as a function of the angular range covered by the group of neighboring pixels.

In examples, a distribution of the azimuth angle associated with the pixels of the group of neighboring pixels can be evaluated based on a matching score relative to the predetermined model. The matching score can be determined based on a comparison between a predetermined model and the distribution of the azimuth angles of the group of neighboring pixels. In one example, when the matching score is greater than a predetermined matching threshold, the group of neighboring pixels for which the distribution of the azimuth angle has been completed is a candidate to be identified as fully or partly belonging to a cloud of particles.

Thus, at the end of the block 140, the data processing device is used to identify whether a group of pixels obtained based on a matrix of pixels of a LIDAR sensor fully or partly belongs to a cloud of particles.

This identification allows, for LiDAR sensors mounted on the vehicles, the interpretation of the matrix of pixels of the LiDAR sensor to be facilitated, notably within the context of driving assistance functions, and more precisely within the context of functions for autonomously driving the vehicle.

Indeed, the clouds of particles, such as the exhaust gases, should not be considered by driving functions of the vehicle as long as they are not dangerous for passengers or for the vehicle. In this sense, the clouds of particles detected by the LiDAR sensor can prove to be troublesome as long as they are considered to be dangerous objects by other functions using the matrix of the LiDAR sensor. In this sense, identifying such particle clouds ultimately allows the fluidity of driving to be improved and the risks for the vehicle passengers and for the vehicle itself to be reduced.

Optionally, and as illustrated by the block 150 shown as dashed lines, the computer also can be configured for determining, for at least one specific pixel of the group of neighboring pixels identified as fully or partly belonging to a cloud of particles, whether the specific pixel belongs to a solid element other than the cloud of particles. This block is advantageously completed for all the pixels of the group of neighboring pixels identified as fully or partly belonging to a cloud of particles.

Several additional examples for determining whether a specific pixel belongs to a solid element other than the cloud of particles can be implemented. Each of the examples can be implemented independently of the others or in addition to the others in order to confirm or disconfirm the identification of a specific pixel as belonging to a solid element other than the cloud of particles. In these examples, the computer can be configured for determining that the pixels of the group of neighboring pixels that have not been determined as corresponding to a solid element other than the cloud of particles correspond to particles of the cloud of particles.

Thus, in examples, the computer can be configured for determining that a specific pixel of the group of neighboring pixels belongs to a solid element other than the cloud of particles based on an intensity associated with this pixel.

In these examples, the computer can be configured for determining that the specific pixel belongs:
to the cloud of particles when an intensity associated with the pixel is less than a determined intensity threshold associated with a solid element; or
to a solid element when an intensity associated with the pixel is greater than the determined intensity threshold associated with the solid element.

An intensity threshold corresponding to a solid element can be determined as a function of a distance of the specific pixel relative to the LiDAR sensor. In this sense, determined intensity thresholds associated with a solid element can be associated with distances as long as the intensity decreases with the distance. In examples, the determined intensity threshold associated with a solid element is determined to be that whose distance is closest to the distance of the specific pixel relative to the LiDAR. In other examples, the determined intensity threshold associated with a solid element is determined by linear interpolation based on predetermined intensity thresholds associated with a solid element, which are also associated with respective distances.

As explained above, a solid element other than the cloud of particles reflects more light beams emitted by the LiDAR than a particle. It is therefore possible to discriminate the pixels of the group of neighboring pixels corresponding to a solid element from those corresponding to particles.

In examples, the computer can be configured for determining whether a specific pixel of the group of neighboring pixels belongs to a solid element other than the cloud of particles based on a distribution of the azimuth angle associated with the pixels of the group of neighboring pixels.

In these examples, the computer can be configured for determining that the specific pixel belongs to a solid element other than the cloud of particles when the azimuth angle associated with the specific pixel belongs to a range of azimuth angles of the distribution that deviates from the predetermined model.

Indeed, the predetermined model of the distribution corresponds to a theoretical representation model of the azimuths of a distribution of particles of a cloud of particles. In this respect, a pixel with an azimuth belonging to a zone that deviates from this model therefore can belong to a solid element other than a particle.

The computer thus can be configured for determining that a specific pixel belongs to a solid element when the azimuth associated with this specific pixel is within a range of azimuth angles of the distribution deviating from the predetermined model by at least a predetermined azimuth deviation threshold.

It is understood that this determination notably can be combined with that which is based on the intensities of the pixels for determining the pixels of the group of neighboring pixels belonging to solid elements other than clouds of particles. Thus, a pixel with an intensity that is greater than the solid element threshold, but is not included in an azimuth angle range of the distribution deviating from the predetermined model, may not be identified as belonging to a solid element. Conversely, a pixel with an azimuth angle that lies within an azimuth angle range of the distribution deviating from the predetermined model but whose intensity is less than the solid element threshold may not be identified as belonging to a solid element.

In examples, the computer can be configured for determining whether a specific pixel of the group of neighboring pixels belongs to a solid element other than the cloud of particles based on the distribution of normal vectors carried out at the end of the block 140.

In these examples, the computer can be configured for determining that the specific pixel belongs to a solid element other than the cloud of particles when the direction of the normal vector associated with the specific pixel belongs to a direction range with a probability of the appearance of a pixel that is greater than for other ranges of the distribution.

Indeed, it has been initially determined that a group of neighboring pixels fully or partly belonged to a cloud of particles based on a substantially homogeneous distribution of the directions of the normal vectors of the vectors. It is now possible to determine which ranges of the distribution of directions deviate from the theoretical distribution of a cloud of particles (perfectly homogeneous), so as to find the pixels belonging to a solid element that thus disrupt the distribution so that it is no longer completely homogeneous.

The computer thus can be configured for determining that a specific pixel belongs to a solid element other than a particle when the direction of the normal vector associated with the specific pixel belongs to a direction range for which a probability of the appearance of a pixel is greater than another range of the distribution of at least one predetermined direction deviation threshold.

In an alternative or additional example, the computer also can be configured for determining that a specific pixel belongs to a solid element other than a particle when the direction of the normal vector associated with the specific pixel belongs to a direction range for which a probability of appearance is greater than a specific probability of appearance of a pixel.

A specific probability of the appearance of a pixel can be determined, for example, based on an average of the probabilities of the appearance of the pixels of the ranges of the distribution and based on a comparison with this average.

As for the previous example, determining that a specific pixel belongs to a solid element when it is based on the direction of the normal vectors can be combined with that based on the distribution of the azimuth angles and/or of the intensity, in any order.

Thus, at the end of the block 150, in addition to having identified which groups of pixels of the matrix of pixels fully or partly belong to clouds of particles, the data processing device is capable of identifying, in each group of pixels, which pixels belong to the cloud of particles and which pixels belong to a solid element other than the cloud of particles.

In this respect, even when a solid object can be combined with a cloud of particles, the data processing device is capable of identifying which information forms part of the cloud of particles and which information forms part of another solid object, to the nearest pixel.

Within the context of a LIDAR sensor mounted on a vehicle, it is understood that the possibility of discriminating which pixels belong to the cloud of particles and which pixels belong to a solid object other than a cloud of particles can allow, for example, the efficiency and the performance capabilities of driver assistance functions to be improved. Indeed, the data processing device that has been described thus allows the information to be identified that is obtained by the LIDAR sensor and is irrelevant for driving the vehicle (i.e., the particles), yet without combining this irrelevant information with other relevant information (the solid objects other than the particles), even if these two types of information can be combined in the matrix of pixels of the LiDAR sensor.

In this sense, the computer 3 of the processing device also can be configured for selecting pixels of the matrix of pixels identified as belonging to solid objects and/or for deleting pixels identified as belonging to the clouds of particles. This allows, for example, only the information relevant for driving to be sent to the functions for assisting said driving or simply allows the irrelevant information to be filtered in order to accelerate the subsequent processing of the matrix of pixels obtained by the LiDAR sensor and used by other functions.

The present disclosure also proposes a method for processing data for a LIDAR sensor mounted on a vehicle. The data processing method can be controlled, for example, by a computer 3 as described above. In this case, the steps carried out by the method mirror the blocks and examples that the computer of the data processing device is configured to control and that have been described above. Thus, both the data processing device and the method described in the present application allow pixels to be identified that correspond to particles suspended in a matrix of pixels of a LIDAR sensor. They also allow, in embodiments, pixels to be discriminated that correspond to solid objects other than particles in a group of pixels fully or partly corresponding to a cloud of particles. These functions are particularly advantageous within the context of a LIDAR 2 mounted on a vehicle, notably for identifying clouds of particles due to exhaust gases and for discriminating a solid object as being another vehicle from a cloud of particles when the cloud and the object are combined into the matrix of pixels.

1. A data processing device (1) for a LIDAR sensor (2) adapted to be mounted on a vehicle (10), the device comprising a computer (3) configured for:
obtaining (110) a matrix of pixels (p) acquired by the LiDAR sensor (2), with each pixel (p) of the matrix being associated with a light intensity (l) and with a position (x, y, z) in a three-dimensional space;
identifying (120) at least one group of neighboring pixels of the matrix of pixels; and,
for at least one identified group of neighboring pixels:
determining (130) a plurality of normal vectors associated with the pixels of the group of neighboring pixels;
identifying (140) whether the group of neighboring pixels fully or partly belongs to a cloud of particles based on a substantially homogeneous distribution of the plurality of normal vectors associated with the pixels of the group of neighboring pixels.

2. The device (1) as claimed in the preceding claim, characterized in that the computer (3) is also configured for determining (150), for at least one specific pixel of the group of neighboring pixels identified as fully or partly belonging to a cloud of particles, whether the specific pixel belongs to a solid element other than the cloud of particles.

3. The device (1) as claimed in the preceding claim, characterized in that the computer (3) is configured for determining that the specific pixel belongs to a solid element when an intensity associated with the pixel is greater than an intensity threshold associated with a determined solid element.

4. The device (1) as claimed in any one of the preceding claims, characterized in that the computer (3) is further configured for determining an average distance of the group of neighboring pixels relative to the LiDAR sensor (2), and in that a group of neighboring pixels is a candidate to be identified as fully or partly belonging to the cloud of particles when an average distance of the pixels of the group of neighboring pixels relative to the LiDAR sensor (2) is less than a predetermined distance threshold.

5. The device (1) as claimed in any one of the preceding claims, characterized in that the computer (3) is further configured for determining an average intensity of the group of neighboring pixels and an average distance of the group of neighboring pixels relative to the LiDAR sensor (2),
and in that a group of neighboring pixels is a candidate to be identified as fully or partly belonging to the cloud of particles when an average intensity of the pixels of the group of neighboring pixels is less than a determined intensity threshold, with the intensity threshold being determined based on the average distance of the group of pixels.

6. The device (1) as claimed in any one of the preceding claims, characterized in that the computer is further configured for determining an azimuth angle for each of the pixels of the group of neighboring pixels, and in that a group of neighboring pixels is a candidate to be identified as fully or partly belonging to the cloud of particles when a distribution of the azimuth angle of the pixels of the group of neighboring pixels substantially corresponds to a predetermined model.

7. The device (1) as claimed in any one of the preceding claims, characterized in that the computer (3) is configured for identifying a group of neighboring pixels as corresponding to a plurality of pixels for which each pixel is at a distance below a predetermined neighboring threshold from another pixel of the group of pixels.

8. A vehicle (10), characterized in that it is fitted with a data processing device (1) as claimed in any one of the preceding claims, in that a LIDAR sensor (2) is mounted at the rear of the vehicle, and in that the computer (3) of the data processing device (1) is configured for identifying a cloud of particles comprising exhaust gas particles.

9. A method for processing data from a LIDAR sensor (2) mounted on a vehicle (10), characterized in that it comprises:
obtaining (110) a matrix of pixels (p) acquired by the LiDAR sensor (2), with each pixel (p) of the matrix being associated with a light intensity (l) and with a position (x, y, z) in a three-dimensional space;
identifying (120) at least one group of neighboring pixels of the matrix of pixels; and,
for at least one identified group of neighboring pixels:
determining (130) a plurality of normal vectors associated with the pixels of the group of neighboring pixels;
identifying (140) whether the group of neighboring pixels fully or partly belongs to a cloud of particles based on a substantially homogeneous distribution of the plurality of normal vectors associated with the pixels of the group of neighboring pixels.

10. The method as claimed in the preceding claim, characterized in that it further comprises determining (150), for at least one specific pixel of the group of neighboring pixels identified as fully or partly belonging to a cloud of particles, whether the specific pixel belongs to a solid element other than the cloud of particles.

11. A computer program product comprising instructions for implementing any one of the above method claims when it is implemented by a computer.

12. A non-transient computer-readable storage medium storing code instructions for implementing a method as claimed in any one of the above method claims.
